(19) United States
(12) Patent Application Publication
(10) Pub. No.: US 2009/0267843 A1
(43) Pub. Date: Oct. 29, 2009

(54) ANTENNA MODULES AND PORTABLE ELECTRONIC DEVICES EMPLOYING THE SAME

(75) Inventors: Ming-Ting Wu, Tu-Cheng (TW); I-Chia Chen, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: Chi Mei Communication Systems, Inc., Tu-Cheng City (TW)

(21) Appl. No.: 12/185,221

(22) Filed: Aug. 4, 2008

(30) Foreign Application Priority Data
Apr. 28, 2008 (CN) 200810301375.6

(51) Int. Cl. H01Q 1/24; H01Q 1/38

(52) U.S. Cl. 343/702; 343/700 MS

(57) ABSTRACT

An antenna module (20) including an antenna holder (21) and an antenna set (40) is provided. The antenna holder includes a top surface (24) and an external end surface (22). The external end surface includes an upper edge (22a) adjacent to the top surface and a lower edge (22b). The antenna set includes a first antenna (42) and a second antenna (44). The second antenna is longer than the first antenna and is mounted on an upper edge of the external end surface. The second antenna includes a main section (444) mounted on a lower edge of the external end surface, a bent section (446) extending from the main section and is mounted on both the up and the lower edges of the external end surface, and an end section (448) extending from the bent section and is mounted on the top surface of the antenna holder.

### BACKGROUND

1. Field of the Invention

The present invention relates to an antenna module for reducing frequency shift and a portable electronic device employing the same.

2. Discussion of the Related Art

As the demand for thin and light cellular phones grows, the design of hidden antennas has become increasingly popular. To minimize the volume of cellular phones, the traces of antennas have to be adequately designed to keep the volume of cellular phones down yet simultaneously achieve stable signal strengths.

Nowadays, high frequency antennas and low frequency antennas are often used together in cellular phones. The antennas are susceptible to interference from electromagnetic waves. As a consequence, to prevent the antennas from electromagnetic interference, the antennas are oriented away from circuit boards of the cellular phones. Additionally, the high frequency antenna and low frequency antenna need to be spaced from each other to avoid a coupling effect, which deteriorates the radiation efficiency. However, for clamshell/flip phones, such a design is only beneficial when the clamshell/flip phone is in an opened state. When the clamshell/flip phone is closed, the radiation efficiency may be deteriorated by frequency shift resulting from the antennas being too close to the cover of the clamshell/flip phones and the variation of the ground area. That is to say, the radiation efficiency of the clamshell/flip phones with such design is ineffective when the clamshell/flip phone is in a closed state.

Therefore, what is needed is an antenna module for reducing frequency shift and a portable electronic device employing the antenna.

### BRIEF DESCRIPTION OF THE DRAWINGS

Many aspects of the antenna module can be better understood with reference to the following drawings. The components in the drawings are not necessarily to scale, the emphasis instead being placed upon clearly illustrating the principles of the present antenna module. Moreover, in the drawings, like reference numerals designate corresponding parts throughout the several views.

FIG. 1 is an isometric view of a portable electronic device equipped with an antenna module according to an exemplary embodiment;

FIG. 2 is an isometric view of an antenna module according to an exemplary embodiment;

FIG. 3 is an isometric view of an antenna module in FIG. 2, but viewed from another aspect;

FIG. 4A shows S₁₁ (the return loss) measurement for a conventional clamshell/flip phone, wherein the x-axis indicates frequency and the y-axis indicates decibel (dB); and

FIG. 4B shows S₁₁ (the return loss) measurement for the antenna module in FIG. 1, wherein the x-axis indicates frequency and the y-axis indicates decibel (dB).

### DETAILED DESCRIPTION OF THE EMBODIMENTS

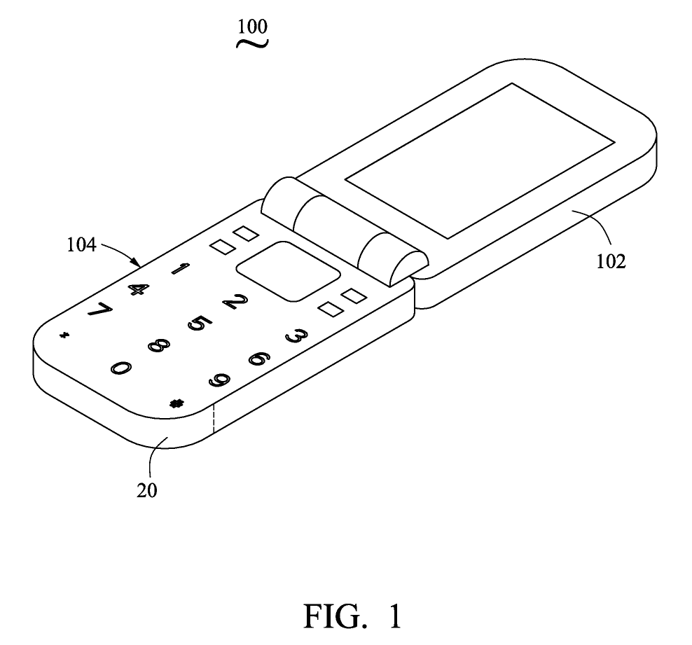

FIG. 1 shows an exemplary portable electronic device 100 modified for reducing frequency shift. The portable electronic device 100 includes a flip cover 102 and a main body 104 connected to the flip cover 102 by a hinge. The main body 104 includes a circuit board (not shown) arranged beneath a keypad (not labeled) and an antenna module 20 electrically connects to the circuit board. The flip cover 102 includes a circuit board (not shown) arranged beneath a display panel (not labeled).

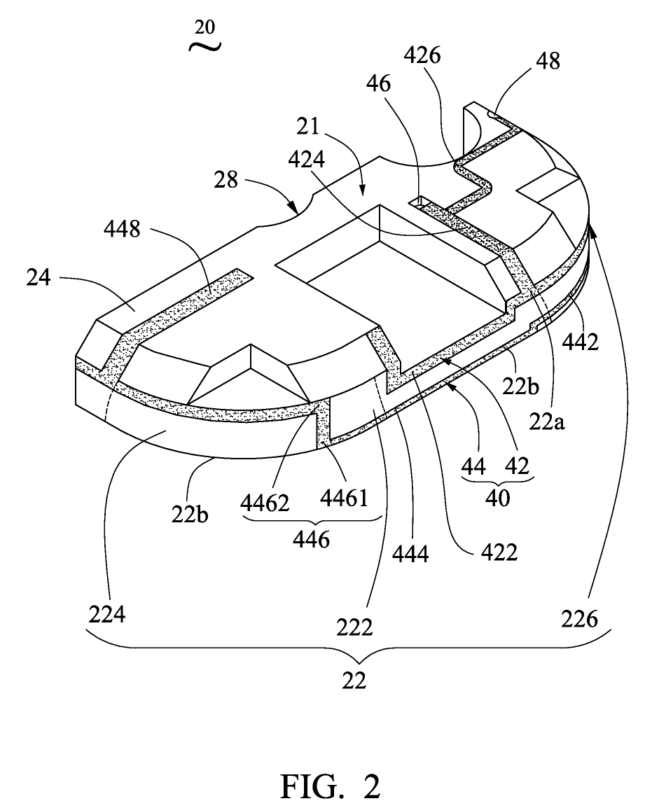

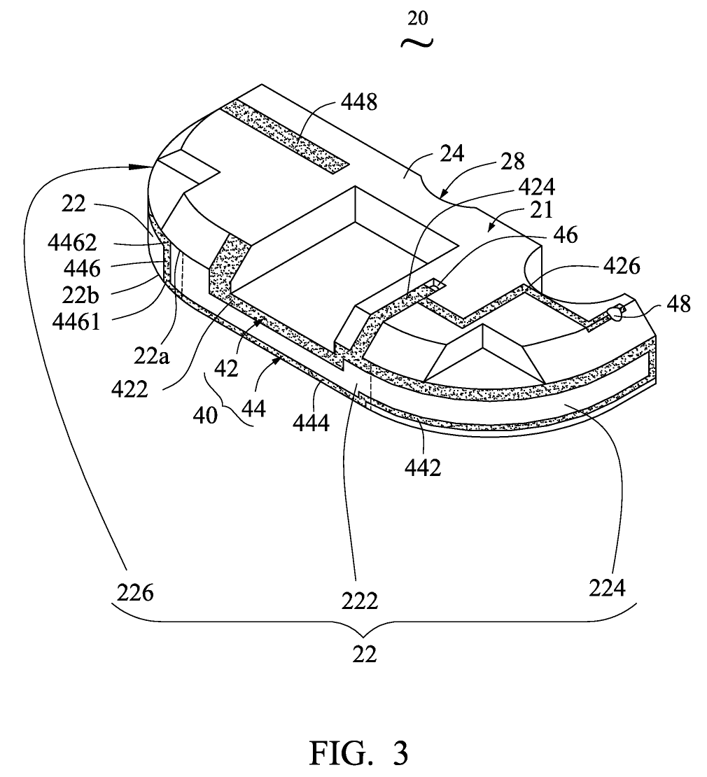

Referring to FIGS. 2 and 3, the antenna module 20 includes an antenna holder 21 and an antenna set 40. The antenna holder 21 has an external end surface 22, a top surface 24, and an internal end surface 28. The external end surface 22 includes a middle portion 222 opposite to the internal end surface 28 and a pair of side portions 224, 226 connected to the middle portion 222. The internal end surface 28 is an attaching plane for assembling the antenna holder 21 to the portable electronic device 100. The external end surface 22 includes an upper edge 22a adjacent to the top surface 24 and a lower edge 22b opposite to the upper edge 22a. The upper edge 22a is connected to the top surface 24.

The antenna set 40 includes a first antenna 42, a second antenna 44, a feed point 46 and a ground 48. The first antenna 42 and the second antenna 44 are mainly mounted on the external end surface 22 of the antenna holder 21, and the feed point 46 and the ground 48 are arranged on the top surface 24 of the antenna holder 21. In the exemplary embodiment, the first antenna 42 is a high frequency antenna and the second antenna 44 is a low frequency antenna. Thus, the first antenna 42 is shorter than the second antenna 44. As shown in FIGS. 2 and 3, the first antenna 42 is mainly mounted along the upper edge 22a of the external end surface 22, and the second antenna 42 is mainly mounted along the lower edge 22b of the external end surface 22.

The first antenna 42 includes a main portion 422, a first connecting portion 424 and a second connecting portion 426. The main portion 422 is mainly mounted on the upper edge 22a of the middle portion 222. The first connecting portion 424 extends from the main portion 422 and is mounted on the top surface 24 so that the first connecting portion 424 connects to the feed point 46. The second connecting portion 426 extends from the first connecting portion 424 and is mounted on the top surface 24 as a meandering-line structure. In addition, the second connecting portion 426 electrically connects to the ground 48 arranged on the top surface 24.

The second antenna 44 includes a front section 442, a main section 444, a bent section 446 and an end section 448. For clearness, dotted lines are shown in FIGS. 2 and 3 for distinguishing different sections of the second antenna 44. Referring to FIG. 3, the front section 442 extends from the main portion 422 of the first antenna 42 and then is mounted on both the upper edge 22a and the lower edge 22b of the external end surface 22 as a meandering-line structure. The main section 444 extends from an end of the front section 442, i.e., it is mounted on the lower edge 22b of the external end surface 22. As shown in FIGS. 2 and 3, the main section 444 is arranged parallel to the first antenna 42. In order to reduce the coupling effect between the first antenna 42 and the second antenna 44, the distance between the first antenna 42 and the second antenna 44 is maximized in accordance with the thickness of the external end surface 22.

The bent section 446 further includes a first bent portion 4461 and a second bent portion 4462. The first bent portion 4461 extends from the main section 444 and is upwardly bent. The second bent portion 4462 extends from the first bent portion 4461 and is bent in a further direction of the first antenna 42 so that it is mounted on the upper edge 22a of the external end surface 22 and does not overlap the first antenna 42. In this way, the first bent portion 4461 and the second bent portion 4462 can prevent the second antenna 44 from being affected by the circuit board within the flip cover 102 as the portable electronic device is in a closed state thereby improving the radiation efficiency of the antenna module 20.

Referring to FIG. 2, the end section 448 extends from the bent section 446, and then is mounted onto the top surface 24 in a direction parallel to the middle portion 222 of the external end surface 222. In this way, please also refer to FIG. 1, the end section 448 is arranged adjacent to the circuit board (not shown) located beneath a keypad of the portable electronic device 100 such that the low frequency path would be suppressed due to ground of the circuit board of the portable electronic device 100.

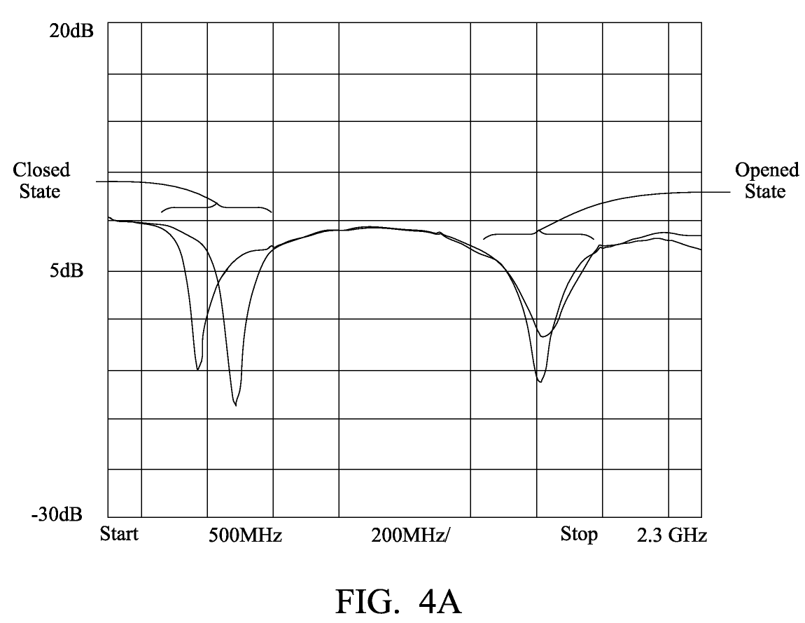

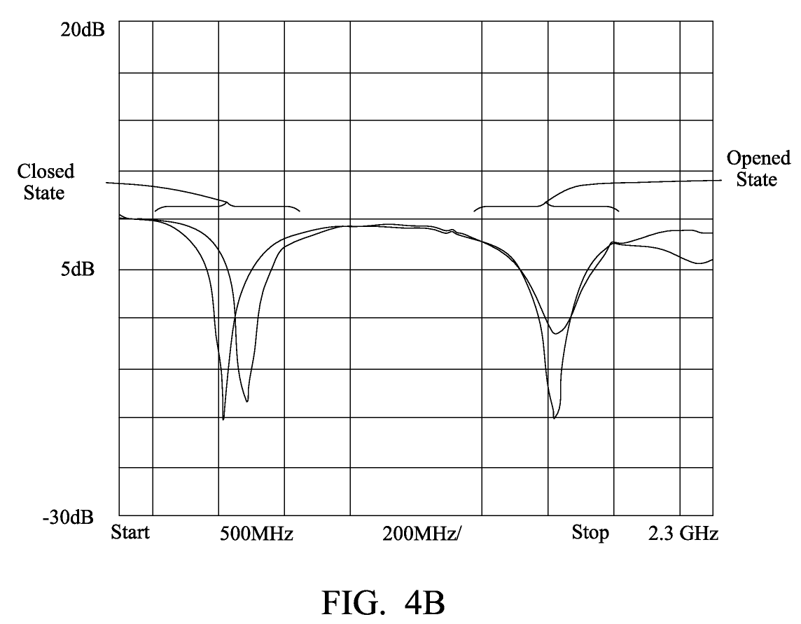

FIG. 4A shows S₁₁ (the return loss) measurement for a conventional clamshell/flip phone. As shown in FIG. 4A, the two curves respectively represent the frequency characteristics of the antennas. There is a small frequency shift between the antennas when the conventional clamshell/flip phone is opened. However, there is a large frequency shift when the conventional clamshell/flip phone is closed. Referring to FIG. 4B, the two curves respectively represent the frequency characteristics of the first antenna 42 and the second antenna 44 of the exemplary embodiment. By contrast, the frequency shift between the first antenna 42 and the second antenna 44 is smaller than that shown in FIG. 4A. In other words, the radiation efficiency of the portable electronic device 100 with such design is stable regardless of whether the portable electronic device 100 is in a closed state or in an opened state.

As described above, the antenna module 20 may be used by various cellular phones, beyond the cellular phone illustrated, and/or with other devices needing an antenna module that facilitates the achievement of fully open and fully closed positions.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An antenna module, comprising:
an antenna holder comprising a top surface and an external end surface, the external end surface comprises an upper edge adjacent to the top surface and a lower edge;
an antenna set comprising a first antenna and a second antenna, the second antenna being longer than the first antenna and being mounted on an upper edge of the external end surface; and
the second antenna comprises a main section mounted on a lower edge of the external end surface, a bent section extending from the main section and is mounted on both the up and the lower edges of the external end surface, and an end section extending from the bent section and is mounted on the top surface of the of the antenna holder.

2. The antenna module as claimed in claim 1, wherein the second antenna further comprises a front section, which is mounted on both upper and lower edges of the external end surface as a meandering-line structure.

3. The antenna module as claimed in claim 2, wherein the external end surface comprises a middle portion opposite to the internal end surface and a pair of side portions connected to the middle portion, the main portion extends from the front section and is mainly mounted on the middle portion.

4. The antenna module as claimed in claim 1, wherein the distance between the main section of the second antenna and the first antenna equals a thickness of the antenna holder.

5. The antenna module as claimed in claim 1, wherein the bent section further comprises a first bent portion and a second bent portion, the first bent portion extends from the main section and is bent upwardly, and the second bent portion extends from the first bent portion and is bent in a further direction of the first antenna so that it is mounted on the upper edge of the external end surface.

6. The antenna module as claimed in claim 1, wherein the first antenna is a high frequency antenna and the second antenna is a low frequency antenna.

7. The antenna module as claimed in claim 1, wherein the antenna set further comprises a feed point and a ground arranged on the top surface of the antenna holder.

8. A portable electronic device, comprising a flip cover and a main body connected to the flip cover via a hinge, the main body comprising a printed circuit board and an antenna module electrically connected to the print circuit board, wherein the antenna module comprising:
an antenna holder comprising a top surface and an external end surface, the external end surface comprises an upper edge adjacent to the top surface and a lower edge;
an antenna set comprising a first antenna and a second antenna, the second antenna being longer than the first antenna and being mounted on an upper edge of the external end surface; and
the second antenna comprises a main section mounted on a lower edge of the external end surface, a bent section extending from the main section and is mounted on both the up and the lower edges of the external end surface, and an end section extending from the bent section and is mounted on the top surface of the of the antenna holder.

9. The portable electronic device as claimed in claim 8, wherein the second antenna further comprises a front section, which is mounted on both upper and lower edges of the external end surface as a meandering-line structure.

10. The portable electronic device as claimed in claim 9, wherein the external end surface comprises a middle portion opposite to the internal end surface and a pair of side portions connected to the middle portion, the main portion extends from the front section and is mainly mounted on the middle portion.

11. The portable electronic device as claimed in claim 8, wherein the distance between the main section of the second antenna and the first antenna equals a thickness of the antenna holder.

12. The portable electronic device as claimed in claim 8, wherein the bent section further comprises a first bent portion and a second bent portion, the first bent portion extends from the main section and is bent upwardly, and the second bent portion extends from the first bent portion and is bent in a further direction of the first antenna so that it is mounted on the upper edge of the external end surface.

13. The portable electronic device as claimed in claim 8, wherein the first antenna is a high frequency antenna and the second antenna is a low frequency antenna.

14. The portable electronic device as claimed in claim 8, wherein the antenna set further comprises a feed point and a ground arranged on the top surface of the antenna holder.
